(19) United States
(12) Patent Application Publication
(10) Pub. No.: US 2002/0178157 A1
(43) Pub. Date: Nov. 28, 2002

(54) Method, device, and computer program product for facilitating a custom design process

(75) Inventors: Frank J. DeGilio, Poughkeepsie, NY (US); Hilon R. Potter, Poughkeepsie, NY (US); Joseph L. Temple III, Hurley, NY (US)

Correspondence Address: IBM Corporation, Intellectual Property Law, 2455 South Road, P386, Poughkeepsie, NY, 16201, US

(73) Assignee: International Business Machines Corporation, Armonk, NY

(21) Appl. No.: 09/865,275

(22) Filed: May 25, 2001

(51) Int. Cl. G06F 7/00

(52) U.S. Cl. 707/4

(57) ABSTRACT

A method, device, and computer program product for facilitating a custom design process are disclosed. The data capture phase of the design process is facilitated by providing two or more data structure types. At least one data structure contains flexible design constraints or inputs. At least one other data structure contains firm or invariant design constraints or inputs At least one data structure of each type is used, however more than one of each type of data structure may be used. Data elements within each data structure are assigned an additional class attribute, the set of class attributes determined by the design method used. The assigned data attributes are used to translate captured data into a final design specification. A tool is disclosed which simplifies data capture, and automates data translation.

### BACKGROUND OF THE INVENTION

1. Technical Field

The present invention relates in general to the field of custom design development, and in particular to a method, system, and program product to facilitate the data gathering and organization steps in a custom design process.

2. Description of Related Art

Facilitating a custom design process involves managing the interaction and information flow between the customer or end user and one or more design professionals. In general, the customer or end user possesses an in-depth knowledge of the environment within which the custom design will be used, and possesses at least some initial understanding of the desirable characteristics of the custom end product. The customer or end user will rarely, however, have an in-depth understanding of the steps involved in translating this initial knowledge into a complex design. Furthermore, the customer or end user will frequently require the assistance of a custom design professional to develop an appreciation for the entire scope of design characteristics involved in a complex custom design. In contrast, the custom design professional will generally have an in-depth knowledge of a detailed custom design method, but will require significant input from the customer or end user in order to define the parameters and specifications of a particular custom design. As the complexity of the final custom design increases, both the input required from the customer and the complexity of the underlying design method tend to increase. This increase in the quantity and complexity of the interaction and information flow generally tends to increase the amount of direct interaction time required between the customer and the custom design professional.

In addition, as the complexity of a custom design increases, the design professional may require the assistance of specialists and other design resources from within the designer's organization, whether to solicit, interpret, or utilize customer input. A designer may engage these resources in the design process by including them in direct customer interaction sessions. Another, more efficient method, is for the design professional to employ a standardized design methodology to solicit and organize customer input during the direct customer interactions. Using a standardized design methodology insures that all necessary information is acquired from the customer, and further that the acquired information is articulated to the specialists and other design resources in a manner that is standardized and therefore easily understood and readily usable.

There is a drawback to this approach, however, if the design professional merely employs the specific inquiries, data formats, and sequencing of the underlying design method to gather and organize customer input: the customer or end user is exposed to the inner workings of the detailed custom design methodology. This may be a drawback for any of several reasons. First, the design professional (or his or her employer) may consider the underlying methodology proprietary, and may wish to keep the details confidential. This may be especially true in circumstances where the design professional is hired as a consultant, and derives income solely from the provision of design services. Second, employing the underlying design methodology during direct customer interaction sessions requires the design professional to explain the underlying design methodology to the customer, at least to some minimal level. The explanations will increase the amount of time required for the direct customer interaction sessions. Finally, this approach may require the customer to interact with the design professional in a way that seems unnatural or awkward to the customer, resulting in lengthy discussions and the possibility that important information is overlooked early in the process.

Such a custom design process may be used in such diverse disciplines as custom architectural designs (residential and commercial), custom vehicle designs (aircraft, automobiles, etc.), custom designs for manufacturing Or office facilities, etc.

While the problems involved in facilitating complex custom designs are common to many disciplines, the problem is particularly important in the area of information technology (IT) products and solutions. While the increases in the performance and diversity of IT solutions provide significant benefits to end users when appropriately applied to solve business and technical problems, the concomitant increases in IT technology complexity have made the “appropriate” application of IT technology an increasingly difficult problem. Frequently, a customer's needs are inadequately met by standard or “off the shelf” IT solutions. Fortunately, the performance, diversity, and custom configurability of modem IT products and solutions provides fertile ground for the development of custom IT products and solutions.

Various methods have been employed within the IT industry to improve customer interaction sessions, however the methods leave room for improvement in the area of custom designs. For example, various issues involving customer interactions within the context of providing IT solutions are described within the following patents and patent applications, each of which is assigned to the same assignee as this application and each of which is hereby incorporated herein by reference in its entirety:

“A Method for Managing A Heterogeneous IT Computer Complex,” Hernandez et al., Ser. No. 09/456274, filed Dec. 7, 1999;

“Computational Workload-Based Hardware Sizer Method, System, and Program Product,” Jayaram et al., Ser. No. 09/183961, filed Nov. 2, 1998;

“Method, System, and Program Product for Performing Cost Analysis of an Information Technology Implementation,” Ruffin, U.S. Pat. No. 6,219,654, issued Apr. 17, 2001;

“Computational Workload-Based Hardware Sizer Method, System, and Program Product,” Ruffin et al., Ser. No. 09/385482, filed Nov. 2, 1998, a divisional of application Ser. No. 09/183961 filed Nov. 2, 1998;

“Method, System, and Program Product for Sizing a Computer System Migration Programming Effort,” Ordonez et al., Ser. No. 09/385176, filed Aug. 30, 1999, a divisional of application Ser. No. 09/183961 filed Nov. 2, 1998;

“Method, System, and Program Product for Determining the Value of a Proposed Technology Modification,” Jayaram et al., Ser. No. 09/386046, filed Aug. 30, 1999, a divisional of application Ser. No. 09/183961 filed Nov. 2, 1998;

“Information Technology Project Assessment Method, System and Program Product,” Morrison et al., Ser. No. 09/385936, filed Aug. 30, 1999, a divisional of application Ser. No. 09/183961 filed Nov. 2, 1998;

“A Method, System, and Program Product for Evaluating a Computational Processing Capacity Migration Between Computer Platforms,” Merenda et al., Ser. No. 09/386057, filed Aug. 30, 1999, a divisional of application Ser. No. 09/183961 filed Nov. 2, 1998.

In particular, several of these patents and applications (U.S. Pat. No. 6,219,654, and application Ser. Nos. 09/456274, 09/385482, and 09/385936) address the problem of gathering and organizing customer inputs, within the limited context of migrating an existing hardware solution to a new set of hardware essentially implementing a similar solution, such as a server consolidation exercise. These methods and devices do not, however, address the adequacy of the existing solution or the underlying business and technical problems, and therefore do not address the development of a custom solution design. The remaining applications (application Ser. Nos. 09/183961, 09/385176, 09/386046, and 09/386057) discuss various tools and methods used in the process of qualifying customers and assessing various aspects of hardware sizings and migration assessments, and also do not address the issue of facilitating a custom design process.

For the foregoing reasons, therefore, there is a need in the art for a method, device, and computer program product to facilitate a custom design process, by providing a natural environment in which a design professional may gather customer inputs for a detailed design and to further translate the acquired input into standardized formats readily understandable and usable to design professionals and specialists.

### SUMMARY OF THE INVENTION

The present invention is directed to a method, device, and computer program product to facilitate a custom design process, by providing a natural environment in which a design professional may gather customer inputs for a detailed design methodology, and to further translate the acquired input into standardized formats readily understandable and usable to design professionals and specialists. In particular, the present invention employs a simple data structure during one or more customer interaction sessions, in order to capture and organize customer inputs. The design professional facilitates a free flow of information from the customer, capturing and storing customer inputs as they occur. The design professional may make further inquiries during the data capture process, in order to capture the information necessary for the underlying design methodology. The data formats of the present invention allow the design professional to make these additional inquiries at context-appropriate points during the customer interaction session, since the data structures do not dictate any particular data capture sequence. Captured inputs are stored in one or more of two or more data structures, such as tables or lists, and displayed in front of the customer during the interaction sessions. During the data capture process, the design professional assigns attributes to each input. These attributes are assigned in a manner that greatly simplifies and facilitates the subsequent translation of the initial data capture tables into the formats used by the underlying design methodology.

In preferred embodiments of the present invention, two categories of data attributes are used. One category determines the table (or tables) within which a particular input is stored during the data capture phases of the process. In the most general embodiment of the present invention, two tables are used: one table is used to store firm or invariant inputs, the other table is used to store flexible or variable inputs. Flexible or variable inputs are inputs which can be changed or have yet to be determined, and may be items such as issues, action items, pending decisions, risks, etc. Invariant inputs are inputs which have been determined and which cannot be altered and may be items such as standards, existing interfaces, non functional requirements, previously made architectural decisions, etc. This aspect of preferred embodiments effectively compresses a number of design method work product tables into a minimal number of easily managed tables or lists. An input is assigned a flexibility attribute (i.e. flexible or invariant), and assigned to the appropriate table based on the assigned attribute. The second attribute assigned to each input is a class attribute, which determines how the particular input will be used during subsequent processes. The set of class attributes is determined by the underlying design methodology.

In preferred embodiments of the present invention, more than one table of each type (i.e. flexible or invariant) may be used. In preferred embodiments of the present invention, up to four input tables may be used. Also in preferred embodiments, four tables are used to store Principles, Requirements, Issues, and Current Decisions.

In one embodiment of the present invention, data tables (or lists) captured during an interaction session are recorded and displayed on easel charts, projected computer screens, white boards, chalk boards or other similar devices, in full view of the customer. The tables or lists contain design information corresponding to the various work products of the design method used. Other work products, particularly diagrams, are directly developed with the customer, and used as focus items for generation of the design data in the tables or lists. In this context, a design methodology work product is defined as am object used by the underlying design methodology to describe and document the custom design. Work products consist of objects such as tables, diagrams, portions of text etc.

The most general embodiments of the present invention employ a single customer interaction session. Preferred embodiments, however, may employ more than one customer interaction session.

In one embodiment of the present invention, the design professional uses the data attributes assigned during the one or more customer interaction sessions to manually generate the set of work products required for the underlying custom design methodology. In preferred embodiments, display devices with data capture capabilities are employed, eliminating the need to manually transcribe the captured inputs.

In preferred embodiments of the present invention, an automated tool is used to simplify and expedite data capture and translation. The tool is ideally computer-based, providing ease of input and automated translation of input tables into design methodology work products. In preferred embodiments using a computer-based tool, inputs may be entered into tables or lists and assigned appropriate attributes by selecting attributes from one or more menus, and typing input text which is stored in accordance with the selected attributes.

In the most general embodiments of the present invention, the underlying custom design methodology may be applied to many types of complex custom designs, such as custom architectural designs (residential and commercial), custom vehicle designs (aircraft, watercraft, automobiles, etc.), custom designs for manufacturing or office facilities, etc. In preferred embodiments, the underlying design methodology is an information technology (IT) product or solution design methodology.

It is therefore an object of the present invention to provide a method, system, and computer program device to facilitate a custom design process.

It is a further object of the present invention to provide a set of data structures used during the data capture phase or phases of a custom design process.

It is a further object of the present invention to provide a set of attributes based upon an underlying detailed design methodology, and to associate one or more data attributes with each input captured during the data capture phase.

It is a further object of the present invention to provide a method whereby the captured inputs and their associated attributes are translated into a design document.

It is a further object of the present invention to provide a computer program product used to capture inputs and automate the data translation process.

The recitation herein of a list of desirable objects which are met by various embodiments of the present invention is not meant to imply or suggest that any or all of these objects are present as essential features, either individually or collectively, in the most general embodiment of the present invention or in any of its more specific embodiments.

### BRIEF DESCRIPTION OF THE DRAWINGS

The subject matter which is regarded as the invention is particularly pointed out and distinctly claimed in the concluding portion of the specification. The invention, however, both as to organization and method of practice, together with further objects and advantages thereof, may best be understood by reference to the following description taken in connection with the accompanying drawings in which:

FIG. 1 illustrates the general flow of assessment and design workshop processes of preferred embodiments of the present invention;

FIG. 2 illustrates the format for a list of principles used in preferred embodiments of the present invention;

FIG. 3 illustrates the format for a list of issues used in preferred embodiments of the present invention;

FIG. 4 illustrates the format for a list of requirements used in preferred embodiments of the present invention;

FIG. 5 illustrates the format for a list of current decisions used in preferred embodiments of the present invention;

FIG. 6 depicts the flow of information from the engagement process into the various work products of the design method of preferred embodiments of the present invention;

FIG. 7 represents the input/list display screen from the program product for the preferred embodiment of preferred embodiments of the present invention;

FIG. 8 depicts the steps by which a program product places text from the captured lists into a template document for design specifications of preferred embodiments of the present invention;

FIG. 9 illustrates an example of an IBM system context diagram which is a design method work product of preferred embodiments of the present invention;

FIG. 10 illustrates the components and logic flow of a computer program product implementing the method of preferred embodiments of the present invention.

### DETAILED DESCRIPTION OF THE INVENTION

While the most general embodiments of the present invention may be advantageously applied to solve a variety of custom design problems, preferred embodiments of the present invention are applied in the context of developing custom IT product solutions. Furthermore, while the most general embodiments of the present invention may involve a single customer interaction session, in preferred embodiments applied in the context of custom IT solutions, two customer interaction sessions are conducted.

### Design Process Overview

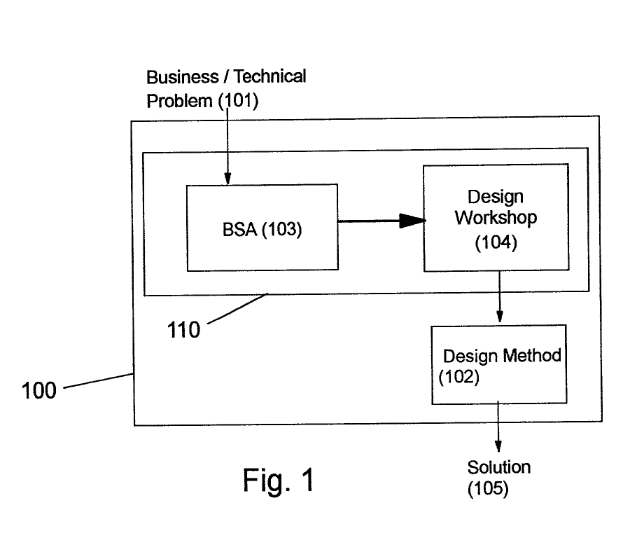

With reference now to FIG. 1., Design Process 100 of a preferred embodiment consists of 2 customer interaction steps: the Business Solution Assessment or BSA 103 and the Design Workshop 104. BSA 103 and Design Workshop 104 are customer interaction sessions, part of the data capture design phase 110. A basic understanding of the customer's Business Problem 101, for which an IT solution is sought, is a first step and the primary focus of the BSA 103. The objective of this customer interaction step is to identify the context of the potential solutions, the constraints on the potential solutions, the resources required, and the scope of the design. The context of the design is the business, social, and/or technical environment within which the new solution will function. The scope of the design is the extent to which the solution will solve a set of problems. The purpose of determining design scope is to avoid “boiling the ocean,” or attempting to create a solution that addresses more problems than can be solved in a reasonable time. Issues which are “out of scope” become irrelevant, whereas those which are “in scope” must be resolved by subsequent design decisions or actions.

During the assessment step 103 of preferred embodiments, a conscious effort is made to avoid making design decisions other than identification of the scope of the design. Rather, the focus of the BSA session 103 is to identify the invariant external constraints and the preexisting issues which are driving the need for a new solution 105. A decision is made whether to proceed with the Design Workshop 104 or to redirect the engagement. Redirection may include deferring the next step until resources, technology, or other issues are resolved.

The Design Workshop 104 uses the context, constraints, and scope decisions developed at the BSA 103, applying client and solution provider resources to create high level design inputs and decisions for a Solution 105. In contrast to the BSA, design decisions are consciously sought out and identified during step 104. In some cases this may cause the emergence of new issues requiring further work or decisions.

An advantage of using the BSA 103 and Design Workshop 104 engagement steps is that in both cases the process uses a concentration of client and solution provider skills in order to generate a solution design in a compressed time frame. In theory, all inflexible or invariant inputs should be articulated and captured in the BSA 103, and design decisions are deferred until the Design Workshop 104. In practice, the methods of the present invention accommodate invariant inputs discovered and captured during the Design 104 phase and decisions articulated during the Assessment 103 phase. Indeed the actual design process may be one continuous customer interaction session, such as illustrated in FIG. 1, 110, or alternatively it may be divided into two or more steps as is convenient for the provider and client. The method and tools of the present invention allow for this flexibility. Preferred embodiments of the present invention separate the process into two or more distinct steps, in order to protect customers from premature design decisions which result from inadequate initial assessment of the requirements, while still accelerating the design process by creating venues for the intense application of resource over short periods of time.

An additional advantage of dividing the data capture phase into two steps may be realized if the BSA 103 step is performed at the customer location, while the Design Workshop is performed at the solution provider's location. Since the focus of the BSA 103 is to develop an understanding of the business problem 101, holding this session at the customer location provides the ability to draw upon additional customer resources as necessary. In contrast, holding session 104 at the solution provider's location provides the ability to draw upon additional design resources as necessary, to facilitate design decisions and issue closure.

At the conclusion of the data capture step or steps (BSA 103 and Design Workshop 104, or the single step 110), a Design Method 102 is used by the provider. The design method 102 supplies formats and discipline for the creation of a set of work products which will define the solution 105. This allows the provider to concentrate on the design task at hand rather than on how to represent the design, since the representation is predefined. It also allows the provider to use previously created templates and to transfer the high level design to implementation teams in a consistent manner as described above. Thus the solution is represented by a design specification document which consists of text sections and various diagrams as prescribed by the Design Method 102. For example, objects such as context, process, flow, and layout diagrams are used by many custom design methods in various disciplines. Context diagrams describe the environment, process and flow diagrams define operations, and layouts describe physical topology of the various elements of the design. The design specification document also contains tables and text, generated from the lists captured by applying the methods and tools of preferred embodiments of the present invention. Since the design method (102) prescribes the types of diagrams and tables which make up a design specification, a template document can be used for all designs created by the practitioner and the tool described below can be used to automatically populate various tables and paragraphs of the template with text.

It is important to understand that the method and tools of the present invention do not automate the design itself, but rather facilitate the recording of input data used to generate the design, and the population of various sections of the design document with text describing the captured input data and design decisions.

### Data Capture During Customer Interaction Sessions

During the data capture phases (103 and 104, or 110), the design professional solicits and captures inputs from the customer. In order to facilitate the discussions, diagrams or templates may be used during the process to illustrate and capture aspects of the customer's business problem 101 and desired solution 105.

Certain diagram templates (blank or sample diagrams) may be included in the design document template, which can be displayed and modified as the design proceeds. For example, the base engineering diagram of an airliner cabin might be used as a template, showing where certain invariant inputs such as exits, ventilation, power, and communication connections must be made. This diagram would be used for each airline cabin customization. The design method would include such a modified diagram as work product, and the “blank” would also be included in the specification template.

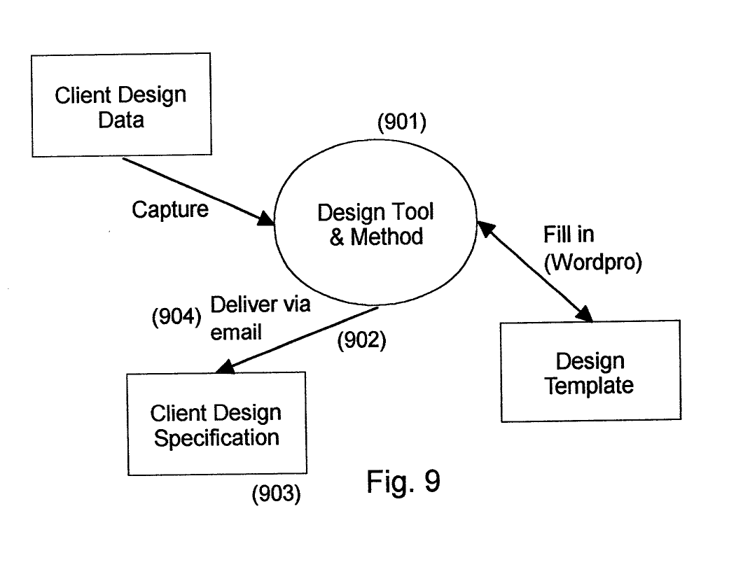

As another example, a “system context diagram” (FIG. 9) may be used in an IT custom design process. As illustrated in FIG. 9, a system context diagram consists of a central circle 901, representing the current design scope, with connecting lines 902 to rectangles 903, which represent the various IT interfaces 904 to systems with which the current design will interact. The detailed labeling and number of interfaces vary from design to design but the basic form is constant. System Context Diagrams such as FIG. 9 are used to facilitate discussion and to document design context. Such a diagram is also useful for discussing and documenting the scope of the solution to be designed.

The various diagrams and charts defined by each design method have similar uses and facilitate the discussions between customer and design professional, which in turn drives capture of the requirements, constraints, and scope of the solution at hand. The context diagram is used for here for illustrative purposes, since preferred embodiments of the present invention employ some variant of a context diagram to facilitate capture of design scope and constraint inputs. Various additional diagrams and design description techniques may be utilized by alternative embodiments of the present invention, as specified by particular design disciplines. In other words, the particulars of such additional diagrams will vary depending on the type of custom design solution involved. Airliner cabin customization, IT infrastructure, building architecture and manufacturing process flow designs may each involve different diagrams during the process of solution definition. In embodiments directed at any of these disciplines, however, a context diagram is likely to prove useful in facilitating an understanding of the context and scope of the custom design project.

During the BSA 103 and Design workshop 104 sessions, tables or lists of information are captured, and posted in view of the client. This is done to organize the information about the constraints and decisions on the design, as well as to record and illustrate progress. The set of tables or lists is the same for both the BSA 103 and the Design Workshop 104.

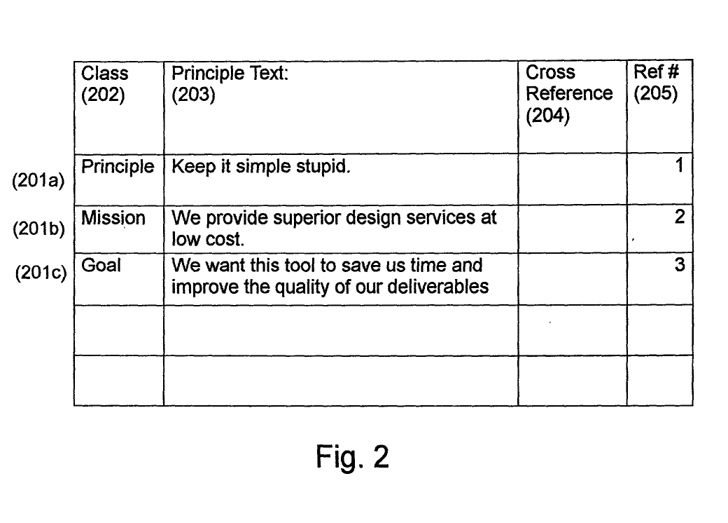

In preferred embodiments of the present invention, one table or list consists of Principles, which may be guiding ideas or principles, mission statements, and design project goals. Referring to FIG. 2, each list entry consists of a class attribute (such as principle, mission statement, goal) 202, text 203, cross references 204 and a reference number 205. The class attribute is used by the provider to capture and organize the inputs during steps 103 and 104 (or 11), and these attributes will also simplify the translation of information when creating the Design Method (101) work products. The specific class attributes used in any particular embodiment are determined by the underlying design method 101. The class attributes described herein are applicable to a preferred embodiment of the present invention, directed at developing custom IT product solutions.

The structure just described with reference to FIG. 2 (Principles) is common to each of the lists generated: each entry contains a class attribute, text, cross references and a reference number. The specific class attributes used may vary from table to table, however the purpose of the class attribute remains constant in all tables. While, in theory, it is possible to create a single list, for practical reasons 2 or more lists are kept. One list, such as the list of principles described above, is a list of customer inputs which cannot be changed by the design. These inputs are described as invariant or inflexible. A second list contains customer inputs which can be changed or need to be resolved by the design. These inputs are described as flexible These two list types, flexible and invariant (or inflexible), represent the minimum number of lists used within the most general embodiments of the present invention.

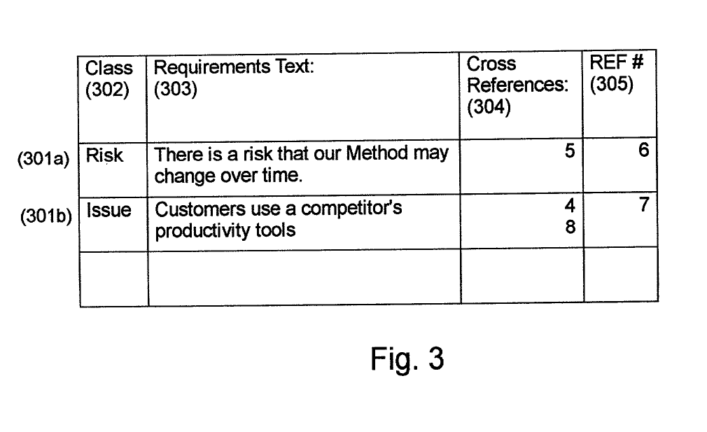

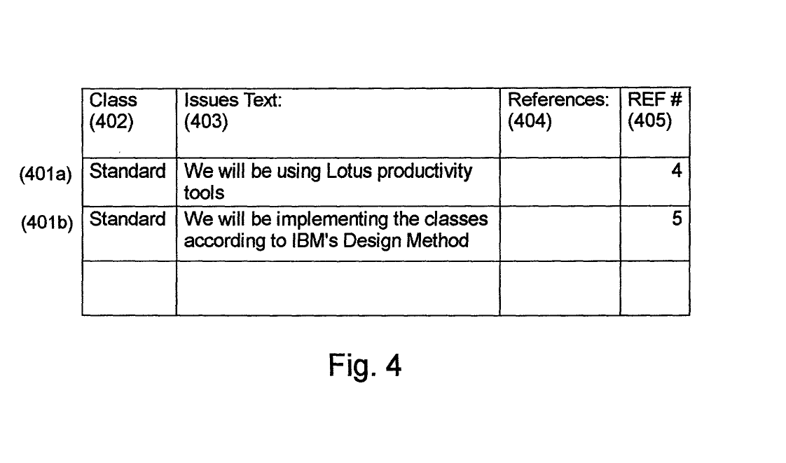

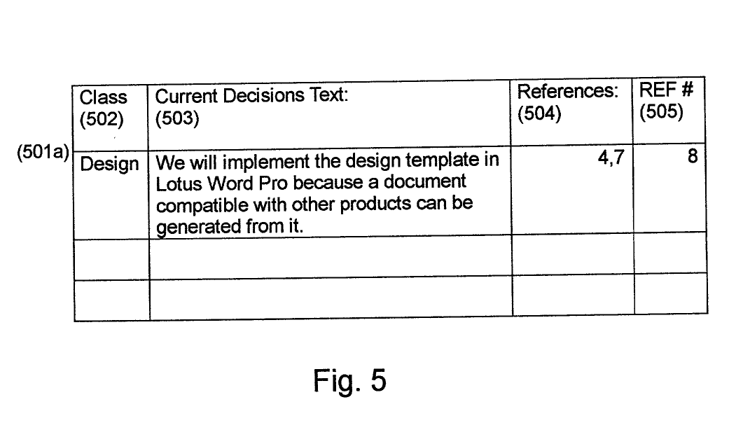

As a further improvement, preferred embodiments of the present invention further divide either of the two basic lists into two lists each: dividing the invariant list into two lists (such as Principles and Requirements) and/or the flexible list into two lists (such as Issues and Current Decisions) is helpful. The use of four lists, two of each type, appears to be an optimal design point, balancing the number of lists versus the separation of inputs into manageable and understandable categories. Of course, 3 lists may be used, and more than 4 lists may also be used, as may be convenient for a particular solution provider. FIG. 3 illustrates an example of a Requirements table 300, used in preferred embodiments of the present invention. FIG. 4 illustrates an example of an Issues table 400, used in preferred embodiments of the present invention. FIG. 5 illustrates an example of a Current Decisions table 500, used in preferred embodiments of the present invention.

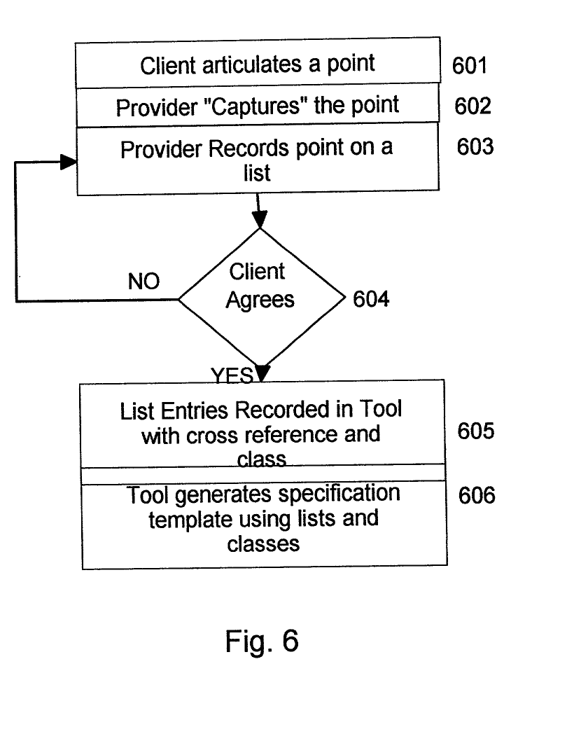

FIG. 6 illustrates the process used during the BSA 103 and workshop 104, to capture and organize customer inputs. During the course of the customer interaction sessions, the provider and client create context, network, flow, or other relevant diagrams, and discuss them. The diagrams are designed to illustrate the customer's environment and design considerations, and facilitate a natural discussion. During the course of these discussions a customer either makes or agrees to key points which become design inputs, such as requirements, issues, or decisions. Referring to FIGS. 2 and 6, when such a point is raised 601 the provider captures it 602 by identifying it as an issue, decision or requirement. Then a list entry is created, 603. The client is asked to agree to the wording of the entree 604 and the entry is modified until the client agrees 603, 604. An index 205 is assigned and any cross references 204 to previous list entries are entered by recording their previously generated reference numbers. A class 202 is assigned by the provider 605, per the underlying design methodology, for later use in generating work products within a specification template 606.

As previously noted, the design method dictates the specific class attributes used during the interaction session or sessions. In particular, a design professional desiring to apply the methods of the present invention to a particular design method, begins by understanding the specific work product objects required in the final design document. Each type of work product within the final design document is represented by one specific class attribute type. By establishing the set of class attributes prior to engaging a customer, the design professional determines in advance the data structures used during the customer interaction sessions. The design professional then applies these class attributes to the data captured during the customer interaction sessions. The resulting populated data structures represent customer inputs, each of which is associated with a class attribute defining the specific role of that input within the final design document. The association of the class attributes with the customer inputs facilitates subsequent translation of the inputs into a final design document.

### Data Translation: Captured Inputs to Design Document

At the close of the data capture phase (steps 103 and 104, or step 110), the solution provider has gathered a set of inputs from the customer which represent the design decisions and constraints developed during the data capture phase. As seen in FIG. 1, the solution provider is now ready to engage the design method 102 in order to complete the design solution 105. As previously noted, an important aspect of the design method step involves translating the inputs captured during the customer interaction sessions (i.e. data capture phase) into a design specification that is easily recognizable and usable by design specialists. The design document also serves to summarize for the customer the progress made during the data capture phase.

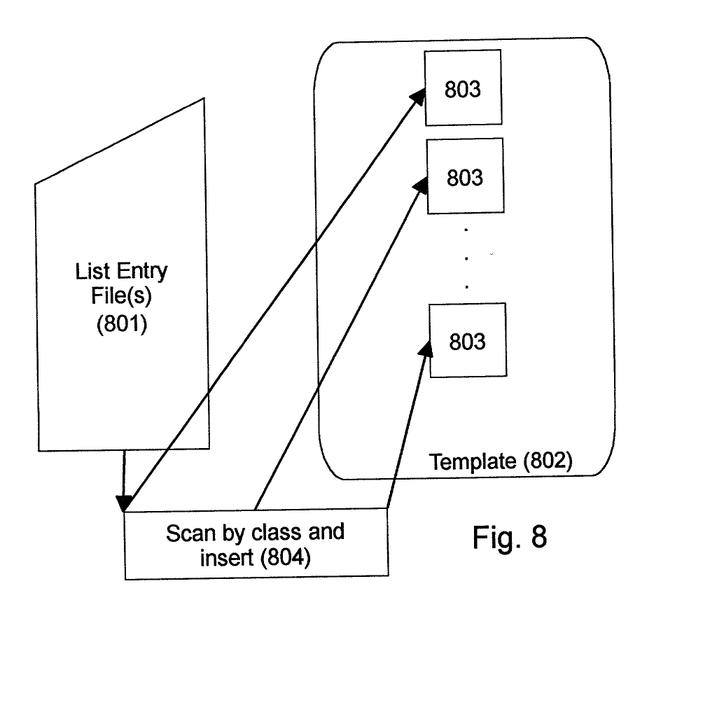

In one embodiment of the present invention the provider manually transcribes the recorded lists into the table and text entries as prescribed by the design method, based upon the classes associated with each input during the interaction sessions 103 and 104 (or the single session 110). Referring now to FIGS. 6 and 8, the provider examines each list entry 801, and at step 804, inserts the text or the table entry 803 into the specification template 802, according to the recorded class of the entry. If the data is recorded in a text file, this is performed by a cut and paste operation common to word processors and text editors. If the data is recorded manually, such as in notes or flip charts, the provider transcribes the information such as by typing the recorded text into the appropriate sections 803 of the specification template 802, again based on the recorded class of the entry. Those skilled in the art will recognize that technology exists for doing the base transcription via devices such as electronic tablets, scanners, and text recognition, or by means of speech recognition hardware and software, all of which are contemplated within the spirit and scope of the present invention. Having created a text file using these means, the procedure would then follow the cut and paste operation as described above.

### Automation

In preferred embodiments of the present invention, the recording of list data is accomplished using a computer program product tool which assists in the list recording, cross referencing, and classification, and which further automates generation of the specification template with work products. Referring now to FIGS. 2, 6 and 7, data entry of list items begins by selecting a class 202, step 605, for the entry from one or more pull down menus 706. This transfers the cursor to the text input area 705, enabling text input for the new list entry, which is then typed in. A reference number 205 is automatically generated for the list entry. Cross references 204 are generated by selecting (such as with a mouse click or other pointing device) the previously generated list entries to be cross referenced. Existing list entries are found in the text windows for Principles 701, Requirements 702, Issues 703, and Decisions 704. Upon completion of the text entry and cross reference selection an enter button 707 is clicked, causing the program to remove the text from the data entry area 705, and appending it to the display area for the chosen list (one of 701-704).

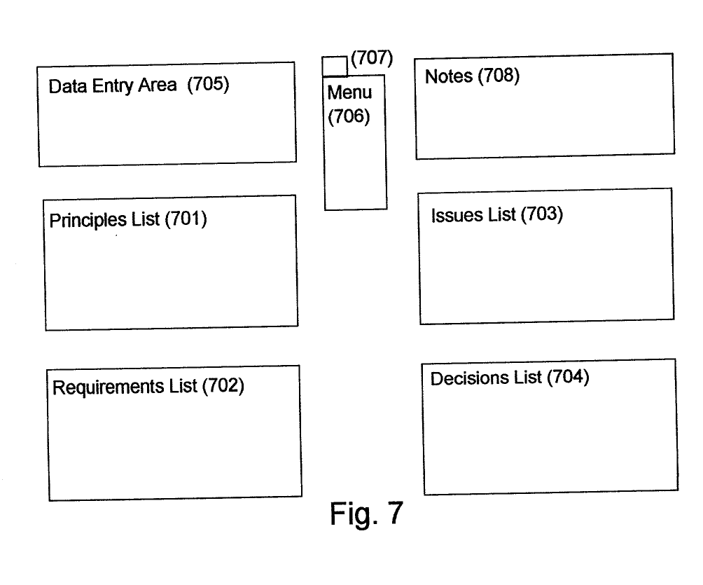

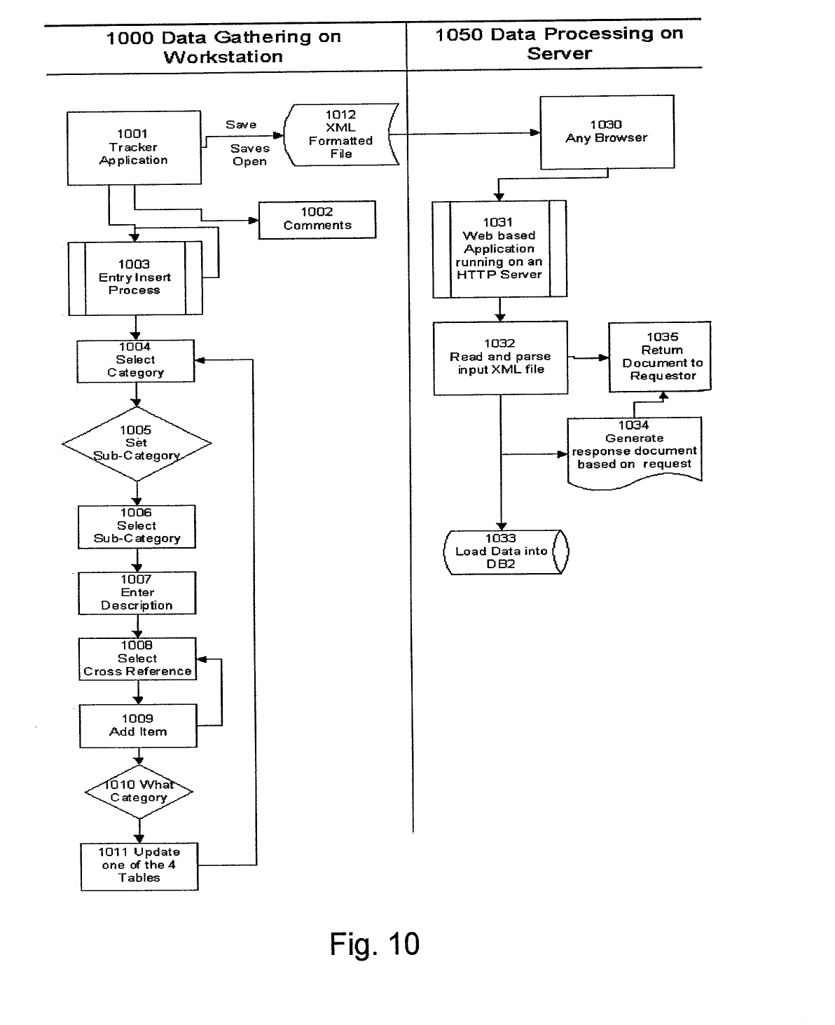

In another embodiment of the invention a data is recorded via transcription or text entry into a tool as described in the discussion of FIG. 7 above, which then automatically populates the specification document with text according the process described in by FIG. 8. A more detailed description of such a tool is now provided, with reference to FIG. 10.

The computer program product automation tool of preferred embodiments consists of two components: the data gathering component, and the data processing component.

The data gathering component is a workstation-based application that allows the user (most likely a design professional or solution provider) to quickly capture customer inputs, and categorize the inputs by applying appropriate attributes. The Tracker Application 1001 comprises a graphical end user interface, and runs on standard workstation operating systems. The user interface comprises three main sections: one for easy entry of comments 1002, one section for easy entry of input item information 1003, and a display section for items previously entered 1010. Items previously entered are displayed by category (i.e. Table type). The Tracker application supports the following actions: File Open, Save, Save As, and Exit. The comments section 1002 is a standard multi-line entry field, and supports rich text entry including cut and paste.

The item information entry section 1003 of preferred embodiments is composed of four fields plus an “add item” button. The application assists the user in adding and categorizing a new entry. First, the initial category field 1004 provides a drop-down menu simplifying user selection of the category (or table type) to apply to this input. In preferred embodiments, the initial category field 1004 merely requires a single letter entry to select the category. Once the user selects the category (or table type), the application presents to the user a list (such as a drop-down list) of class types (or sub-categories) that are specific to the selected category (table type). In this way, the user is only presented with the specific classes which the underlying design method allows for this category. In the alternative, the class or sub-category can be selected by selecting the first letter of the sub-category, 1006. The user next completes the description field 1007, a text entry field. The final field for the new entry is the cross reference field 1008. The application presents the user with a drop-down list showing previous entries, in order to assist the user in selecting appropriate cross references. The “add item” button is now used to process the entered and selected data 1009. The application assigns an index number to the entry, and adds the entry to the cross reference pull down list. The entry is then added to the appropriate table, based upon the selected category 1010. In preferred embodiments of the present invention, four categories or table types are used. The entry fields are now cleared, and the application is ready to accept another input entry.

When the Save or Save As action is selected, the data is extracted from the comments text field, and the four tables are formatted into an XML document, then saved on the workstation. This file may be opened and reedited as needed, such as in a subsequent Design Workshop 104.

Preferred embodiments of the present invention also include a data processing section. With reference to FIG. 10, the data processing section is a web-based application, consisting of a standard web browser which supports file upload 1030, and a server-side application 1031. The server application 1031 takes the incoming request (the XML file created during the Save or Save As action), and the request type, and parses the XML file 1032. The data is then entered into a database 1033. In preferred embodiments, database 1033 is a DB2 database. Based upon the request type and the specific formats dictated by the design method, a design specification document is created 1034. The design document is then returned 1035 to the browser at the user's workstation 1030, to be further processed within appropriate applications resident on the user's workstation. Once the data is in the DB2 table it can be accessed at a later time to generate additional collateral or to do data mining.

### Illustrative Example

The example provided herein represents a portion of the preliminary specification of the tool to implement the present invention.

During the initial assessment the first thought expressed was the need for our method to be simple. The famous “KISS —Keep It Simple Stupid” principle was expressed as one which should guide us in creation of the tool. This was recorded in the “Principles Table” (FIG. 2) as entry 201a and was assigned the reference number 1. We stated our mission statement was articulated and entered as entry 201b and assigned reference number 2. Our goal was stated and entered as entry 201c and assigned reference number 3.

After further discussion we discovered requirements which were recorded in the requirement table (FIG. 4) as entry 401a“we will be using Lotus products” and 401b“we will implement the list classes according to the IBM design method.” These requirements were assigned reference numbers 4 and 5.

Subsequently the requirement to use the IBM design method for the classes caused a risk to be discovered and recorded in the issues list (FIG. 3.) This is recorded as “There is a risk that our design method may change over time,” entry 301a, and assigned a reference number of 6. This entry also has as a cross reference #5 since it refers to the requirement to use the IBM design method classes.

Then an issue was raised that many of our customers use a competitor's tools. This was entered into the issues list (FIG. 3) as entry 301b and assigned reference number 7, with cross reference to #4.

During the design we determined that the document template would be done in Lotus WordPro, because it was a Lotus product addressing requirement #4 and could be used to generate a document compatible with competitive tools, thereby resolving issue #7. This was entered into the decisions list (FIG. 5) and assigned the reference number 8. This was added as a forward cross reference to (FIG. 3) entry 301b

The various design points articulated above are illustrated in the system context diagram shown in FIG. 9

An outline of the design template would look something like this:

I. Introduction

Missions

Goals

Principles

II. Context

III. Requirements

IV. Issues

V. Risks

VI. Decisions

The Template text created from these list entries by the tool would be paragraphs in the Mission, Principles and Goals introductory sections of the template document, and table entries in the standards, risks, issues and design decisions tables in the template document.

While the invention has been described in detail herein in accord with certain preferred embodiments thereof, many modifications and changes therein may be effected by those skilled in the art. Accordingly, it is intended by the appended claims to cover all such modifications and changes as fall within the true spirit and scope of the invention.

What is claimed is:

1. A method of facilitating the information gathering and documentation phases of a custom design process, said method comprising the steps of:
generating a first set of data structures for storing design constraint information, said first set of data structures comprising two or more tables, at least one of said tables in said first set being used to store firm design constraints, at least one other of said tables in said first set being used to hold flexible design constraints; and
determining said design constraint information; and
storing said design constraint information in at least one of said two or more tables; and
assigning a class attribute to each design constraint; and
generating a second set of data structures for processing said design constraint information, said second set of data structures being greater in number than said first set, said class attributes determining the relationship between said first set of data structures and said second set of data structures; and
translating said stored design constraint information from said first set of data structures into said second set of data structures for subsequent processing during said custom design process.

2. The method of claim 1, wherein said custom design process is an information technology architecture design process.

3. The method of claim 1, wherein said first set of data structures comprises a plurality of tables for storing firm design constraints.

4. The method of claim 1, wherein said first set of data structures comprises a plurality of tables for storing flexible design constraints.

5. The method of claim 1, wherein said storing is performed on an electronic computer.

6. The method of claim 5, wherein said translating is performed by said electronic computer.

7. At least one program storage device readable by a machine tangibly embodying at least one program of instructions executable by machine to perform a method for facilitating the information gathering and documentation phases of a custom design process, said method comprising the steps of:
generating a first set of data structures for storing design constraint information, said first set of data structures comprising two or more tables, at least one of said tables in said first set being used to store firm design constraints, at least one other of said tables in said first set being used to hold flexible design constraints; and
determining said design constraint information; and
storing said design constraint information in at least one of said two or more tables; and
assigning a class attribute to each design constraint, and
generating a second set of data structures for processing said design constraint information, said second set of data structures being greater in number than said first set, said class attributes determining the relationship between said first set of data structures and said second set of data structures; and
translating said stored design constraint information from said first set of data structures into said second set of data structures for subsequent processing during said custom design process.

8. The method of claim 7, wherein said custom design process is an information technology architecture design process.

9. The method of claim 7, wherein said first set of data structures comprises a plurality of tables for storing firm design constraints.

10. The method of claim 7, wherein said first set of data structures comprises a plurality of tables for storing flexible design constraints.

11. A device for facilitating the information gathering and documentation phases of a custom design process, said device comprising:
an input device for entering design constraint information;
storage means for storing said design constraint information, including at least one data structure storing flexible design constraints, and further including at least one data structure storing firm design constraints;
association means for assigning one or more attributes to each of said design constraints;
a display for presenting said stored design constraints and assigned attributes to a user;
a processor for translating said stored design constraint information from said stored data structures into a structured design document for subsequent processing during said custom design process.

12. The device of claim 11, wherein said custom design process is an information technology architecture design process.

13. The device of claim 11, wherein a plurality of data structures store flexible design constraints.

14. The device of claim 11, wherein a plurality of data structures store firm design constraints.

15. The device of claim 11, wherein said processor is an electronic computer.

16. The device of claim 15, wherein said input device is a pointing device.

17. The device of claim 15, wherein said input device is a text input device.
